(19) United States
(12) Patent Application Publication
(10) Pub. No.: US 2025/0095659 A1
(43) Pub. Date: Mar. 20, 2025

(54) EFFICIENT LOUDSPEAKER SURFACE SEARCH FOR MULTICHANNEL LOUDSPEAKER SYSTEMS

(71) Applicant: NOKIA TECHNOLOGIES OY, Espoo (FI)

(72) Inventors: Mikko-Ville LAITINEN, Espoo (FI); Tapani PIHLAJAKUJA, Kellokoski (FI); Juha Tapio VILKAMO, Helsinki (FI)

(21) Appl. No.: 18/728,919

(22) PCT Filed: Jan. 18, 2022
(86) PCT No.: PCT/FI2022/050030

§ 371 Date: Jul. 15, 2024

(51) Int. Cl. G10L 19/008; G10L 19/02; H04S 7/00

(52) U.S. Cl. CPC G10L 19/008; G10L 19/02; H04S 7/30

(57) ABSTRACT

An apparatus for spatial audio signal decoding and rendering associated with a plurality of speaker nodes placed within a three-dimensional space having virtual surface arrangement comprising a plurality of virtual surfaces. The apparatus determines an azimuth angle for each virtual surface of the virtual surface set and the arrange the virtual surfaces of the virtual surface set into an order based on azimuth angles to give an ordered virtual surface set. The apparatus then associates a virtual surface of the ordered virtual surface set to a search sector and starting from the associated virtual surface for the search sector, search the ordered virtual surface set to determine a virtual surface that encloses a target panning direction.

### FIELD

The present application relates to apparatus and methods for spatial sound reproduction using multichannel loudspeaker systems. This includes but is not exclusively for systems where the multichannel loudspeaker setup is a virtual multichannel loudspeaker setup.

### BACKGROUND

Parametric spatial audio processing is a field of audio signal processing where the spatial aspect of the sound is described using a set of parameters. For example, in parametric spatial audio capture from microphone arrays, it is a typical and an effective choice to estimate from the microphone array signals a set of parameters such as directions of the sound in frequency bands, and the ratio parameters expressing relative energies of the directional and non-directional parts of the captured sound in frequency bands. These parameters are known to well describe the perceptual spatial properties of the captured sound at the position of the microphone array. These parameters can be utilized in synthesis of the spatial sound accordingly, for headphones binaurally, for loudspeakers, or to other formats, such as Ambisonics.

The directions and direct-to-total energy ratios in frequency bands are thus a parameterization that is particularly effective for spatial audio capture.

A parameter set consisting of a direction parameter in frequency bands and an energy ratio parameter in frequency bands (indicating the proportion of the sound energy that is directional) can be also utilized as the spatial metadata for an audio codec. For example, these parameters can be estimated from microphone-array captured audio signals, and for example a stereo signal can be generated from the microphone array signals to be conveyed with the spatial metadata. The stereo signal could be encoded, for example, with an AAC encoder. A decoder can decode the audio signals into PCM signals and process the sound in frequency bands (using the spatial metadata) to obtain the spatial output, for example a binaural output.

Reproduction of the spatial audio signals (Spatial sound reproduction) typically requires positioning sound in 3D space to arbitrary directions. These directions may be obtained automatically, e.g., from sound scene parameters, or they may be set by the user. Vector base amplitude panning (VBAP) is a common method to position spatial audio signals using loudspeaker setups.

VBAP is typically based on
1) automatically or manually triangulating the loudspeaker setup,
2) selecting appropriate triangle(s) based on the direction (such that for a given direction three loudspeakers are selected which form a triangle where the given direction falls in), and
3) computing gains based on the direction for the three loudspeakers forming the particular triangle.

### SUMMARY

There is provided according to a first aspect an apparatus for spatial audio signal decoding and rendering associated with a plurality of speaker nodes placed within a three dimensional space having virtual surface arrangement comprising a plurality of virtual surfaces, wherein each of the plurality of virtual surfaces has corners positioned at at least three speaker nodes, wherein the virtual surface arrangement is defined at least in part by a virtual surface set comprising a plurality of virtual surfaces, wherein each of the plurality of virtual surfaces is each referenced by a reference means, and wherein the apparatus is configured to: determine an azimuth angle for each virtual surface of the virtual surface set; arrange the virtual surfaces of the virtual surface set into an order based on the determined azimuth angles to give an ordered virtual surface set; determine at least two search sectors, wherein each of the at least two search sectors occupies a range of azimuth angles; associate a virtual surface of the ordered virtual surface set to each of the at least two search sectors; obtain a target panning direction comprising at least a target azimuth angle; determine a search sector from the at least two search sectors based on the target azimuth angle, and; start from the associated virtual surface for the determined search sector, search the ordered virtual surface set to determine a virtual surface that encloses the target panning direction.

The reference means can be an index.

The apparatus configured to start from the associated virtual surface for the determined search sector, search the ordered virtual surface set to determine a virtual surface that encloses the target panning direction may be further configured to: determine an initial search index for the determined search sector, wherein the initial search index is an index of the associated virtual surface for the determined search sector; determine a set of panning gains for the at least three speaker nodes of the associated virtual surface for the determined search sector; and determine that the associated virtual surface encloses the target panning direction when each panning gain is non-negative of the set of panning gains for the at least three speaker nodes of the associated virtual surface for the determined sector.

When at least one panning gain of the set of panning gains for the speaker nodes of the associated virtual surface for the determined sector is not non-negative, the apparatus may be further configured to: select a further virtual surface from the ordered virtual set with an index which lies to one side of the initial search index; determine a set of panning gains for the at least three speaker nodes of the further virtual surface; and determine that the further virtual surface encloses the target planning direction when each panning gain is non-negative of the set of panning gains for the at least three speaker nodes of the further virtual surface; and when at least one panning gain of the set of panning gains for the at least three speaker nodes of the further virtual surface is not non-negative, the apparatus may be further configured to: select a yet further virtual surface from the ordered virtual set with an index which lies to the other side of the initial search index; determine a set of panning gains for the at least three speaker nodes of the yet further virtual surface; and determine that the yet further virtual surface encloses the target planning direction when each panning gain is non-negative of the set of panning gains for the at least three speaker nodes of the yet further virtual surface.

Each of the plurality of virtual surfaces may be defined by at least three vectors each pointing to one of the at least three speaker nodes, wherein the apparatus configured to determine an azimuth angle for each virtual surface of the virtual surface set may be configured to: determine, for each virtual surface, a vector sum of the at least three vectors; and determine the azimuth angle, for each virtual surface, as an angle of the vector sum projected onto a x-y plane.

An azimuth angle for the associated virtual surface is a border angle for the determined search sector, wherein the apparatus configured to start from the associated virtual surface for the determined search sector, search the ordered virtual surface set to determine a virtual surface that encloses the target panning direction may be further configured to: determine whether the target azimuth angle is less than the azimuth angle for the associated virtual surface azimuth angle; when the target azimuth angle is less than the azimuth angle for the associated virtual surface the apparatus may be configured to determine that the associated virtual surface encloses the target panning direction and determine a set of panning gains for the at least three speaker nodes of the associated virtual surface for the determined search sector; and when the target azimuth angle is not less than the azimuth angle for the associated virtual surface the apparatus may be configured to determine that when the target azimuth angle is less than a border azimuth angle for a further virtual surface of the ordered virtual surface set that the further virtual surface encloses the target panning direction and determine a set of panning gains for the at least three speaker nodes of the further virtual surface.

Each of the plurality of virtual surfaces may be defined by at least three vectors each pointing to one of the at least three speaker nodes, wherein the apparatus configured determine an azimuth angle for each virtual surface of the virtual surface set may be configured to: determine, for each virtual surface, a first azimuth angle of a first of the at least three vectors; determine, for each virtual surface, a second azimuth angle of a second of the at least three vectors; and select the azimuth angle for each virtual surface as the larger of the first azimuth angle and the second azimuth angle.

The apparatus may be further configured to: obtain an elevation angle for a horizontal plane within the three-dimensional space, wherein a number of the plurality of speaker nodes are situated on the horizontal plane; and create an elevation angle range between a minimum elevation angle and the elevation angle for the horizontal plane.

The apparatus may be further configured to create a further elevation angle range between the elevation angle for the horizontal plane and a maximum elevation angle.

The apparatus may be further configured to: obtain an elevation angle for a further horizontal plane within the three-dimensional space, wherein a further number of the plurality of speaker nodes are situated on the further horizontal plane; and create a further elevation angle range between the elevation angle for the horizontal plane and the elevation angle for the further horizontal plane.

The apparatus may be further configured to create a yet further elevation angle range between the elevation angle for the further horizontal plane and a maximum elevation angle.

The apparatus may be further configured to assign the virtual surface set to one of; the elevation angle range, the further elevation angle range and yet further elevation angle range by mapping an elevation angle associated with the virtual surface set to one of; the elevation angle range, the further elevation angle range and yet further elevation angle range.

The target panning direction may further comprises a target elevation angle, and wherein the apparatus may be further configured to determine that the target elevation angle lies within one of: the elevation angle range, the further elevation angle range and yet further elevation angle range to give a determined elevation range.

The plurality of virtual surfaces with corners positioned at at least three speaker nodes of the plurality of speaker nodes may have sides connecting pairs of corners configured to be non-intersecting with the horizontal plane within the three-dimensional space.

Alternatively, the plurality of virtual surfaces with corners positioned at at least three speaker nodes may have sides connecting pairs of corners configured to be non-intersecting with the further horizontal plane within the three-dimensional space.

The order of virtual surfaces of the virtual surface set may ne an increasing order of the determined azimuth angles of the virtual surfaces.

The virtual surface may be a loudspeaker triplet comprising three vectors each pointing to a corner of the loudspeaker triplet.

There is provided according to a second aspect a method for spatial audio signal decoding and rendering associated with a plurality of speaker nodes placed within a three dimensional space having virtual surface arrangement comprising a plurality of virtual surfaces, wherein each of the plurality of virtual surfaces has corners positioned at at least three speaker nodes, wherein the virtual surface arrangement is defined at least in part by a virtual surface set comprising a plurality of virtual surfaces, wherein each of the plurality of virtual surfaces is each referenced by a reference means, and wherein the method comprises:

determining an azimuth angle for each virtual surface of the virtual surface set; arranging the virtual surfaces of the virtual surface set into an order based on the determined azimuth angles to give an ordered virtual surface set; determining at least two search sectors, wherein each of the at least two search sectors occupies a range of azimuth angles; associating a virtual surface of the ordered virtual surface set to each of the at least two search sectors; obtaining a target panning direction comprising at least a target azimuth angle; determining a search sector from the at least two search sectors based on the target azimuth angle; and starting from the associated virtual surface for the determined search sector, search the ordered virtual surface set to determine a virtual surface that encloses the target panning direction.

The reference means is an index.

Starting from the associated virtual surface for the determined search sector, search the ordered virtual surface set to determine a virtual surface that encloses the target panning direction may further comprise: determining an initial search index for the determined search sector, wherein the initial search index is an index of the associated virtual surface for the determined search sector; determining a set of panning gains for the at least three speaker nodes of the associated virtual surface for the determined search sector; and determining that the associated virtual surface encloses the target panning direction when each panning gain is non-negative of the set of panning gains for the at least three speaker nodes of the associated virtual surface for the determined sector.

When at least one panning gain of the set of panning gains for the speaker nodes of the associated virtual surface for the determined sector is not non-negative, the method may further comprise: selecting a further virtual surface from the ordered virtual set with an index which lies to one side of the initial search index; determining a set of panning gains for the at least three speaker nodes of the further virtual surface; and determining that the further virtual surface encloses the target planning direction when each panning gain is non-negative of the set of panning gains for the at least three speaker nodes of the further virtual surface; and when at least one panning gain of the set of panning gains for the at least three speaker nodes of the further virtual surface is not non-negative, the method may further comprise: selecting a yet further virtual surface from the ordered virtual set with an index which lies to the other side of the initial search index; determining a set of panning gains for the at least three speaker nodes of the yet further virtual surface; and determining that the yet further virtual surface encloses the target planning direction when each panning gain is non-negative of the set of panning gains for the at least three speaker nodes of the yet further virtual surface.

Each of the plurality of virtual surfaces may be defined by at least three vectors each pointing to one of the at least three speaker nodes, wherein the determining an azimuth angle for each virtual surface of the virtual surface set may further comprise: determining, for each virtual surface, a vector sum of the at least three vectors; and determining the azimuth angle, for each virtual surface, as an angle of the vector sum projected onto a x-y plane.

An azimuth angle for the associated virtual surface may be a border angle for the determined search sector, wherein starting from the associated virtual surface for the determined search sector, search the ordered virtual surface set to determine a virtual surface that encloses the target panning direction may further comprise: determining whether the target azimuth angle is less than the azimuth angle for the associated virtual surface azimuth angle; when the target azimuth angle is less than the azimuth angle for the associated virtual surface the method may further comprise determining that the associated virtual surface encloses the target panning direction and determining a set of panning gains for the at least three speaker nodes of the associated virtual surface for the determined search sector; and when the target azimuth angle is not less than the azimuth angle for the associated virtual surface the method may further comprise determining that when the target azimuth angle is less than a border azimuth angle for a further virtual surface of the ordered virtual surface set that the further virtual surface encloses the target panning direction and determining a set of panning gains for the at least three speaker nodes of the further virtual surface.

Each of the plurality of virtual surfaces may be defined by at least three vectors each pointing to one of the at least three speaker nodes, wherein the determining an azimuth angle for each virtual surface of the virtual surface set may comprise: determining, for each virtual surface, a first azimuth angle of a first of the at least three vectors; determining, for each virtual surface, a second azimuth angle of a second of the at least three vectors; and selecting the azimuth angle for each virtual surface as the larger of the first azimuth angle and the second azimuth angle.

The method may further comprise: obtaining an elevation angle for a horizontal plane within the three-dimensional space, wherein a number of the plurality of speaker nodes are situated on the horizontal plane; and creating an elevation angle range between a minimum elevation angle and the elevation angle for the horizontal plane.

The method may further comprise creating a further elevation angle range between the elevation angle for the horizontal plane and a maximum elevation angle

The method may further comprise: obtaining an elevation angle for a further horizontal plane within the three-dimensional space, wherein a further number of the plurality of speaker nodes are situated on the further horizontal plane; and creating a further elevation angle range between the elevation angle for the horizontal plane and the elevation angle for the further horizontal plane.

The method may further comprise creating a yet further elevation angle range between the elevation angle for the further horizontal plane and a maximum elevation angle.

The method may further comprise assigning the virtual surface set to one of; the elevation angle range, the further elevation angle range and yet further elevation angle range by mapping an elevation angle associated with the virtual surface set to one of; the elevation angle range, the further elevation angle range and yet further elevation angle range.

The target panning direction may further comprise a target elevation angle, and wherein the method may further comprise determining that the target elevation angle lies within one of: the elevation angle range, the further elevation angle range and yet further elevation angle range to give a determined elevation range.

The plurality of virtual surfaces with corners positioned at at least three speaker nodes of the plurality of speaker nodes may have sides connecting pairs of corners configured to be non-intersecting with the horizontal plane within the three-dimensional space.

The plurality of virtual surfaces with corners positioned at at least three speaker nodes may have sides connecting pairs of corners configured to be non-intersecting with the further horizontal plane within the three-dimensional space.

The order of virtual surfaces of the virtual surface set may be an increasing order of the determined azimuth angles of the virtual surfaces.

A virtual surface may be a loudspeaker triplet comprising three vectors each pointing to a corner of the loudspeaker triplet.

There is provided according to a third aspect an apparatus for spatial audio signal decoding and rendering associated with a plurality of speaker nodes placed within a three dimensional space having virtual surface arrangement comprising a plurality of virtual surfaces, wherein each of the plurality of virtual surfaces has corners positioned at at least three speaker nodes, wherein the virtual surface arrangement is defined at least in part by a virtual surface set comprising a plurality of virtual surfaces, wherein each of the plurality of virtual surfaces is each referenced by a reference means, wherein the apparatus comprises at least one processor and at least one memory including a computer program code, the at least one memory and the computer program code configured to, with the at least one processor, cause the apparatus at least to: determine an azimuth angle for each virtual surface of the virtual surface set; arrange the virtual surfaces of the virtual surface set into an order based on the determined azimuth angles to give an ordered virtual surface set; determine at least two search sectors, wherein each of the at least two search sectors occupies a range of azimuth angles; associate a virtual surface of the ordered virtual surface set to each of the at least two search sectors; obtain a target panning direction comprising at least a target azimuth angle; determine a search sector from the at least two search sectors based on the target azimuth angle, and; start from the associated virtual surface for the determined search sector, search the ordered virtual surface set to determine a virtual surface that encloses the target panning direction.

A non-transitory computer readable medium comprising program instructions for causing an apparatus to perform the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a vector base amplitude panning example comprising a loudspeaker triplet and active triangle;

FIG. 2 shows schematically a vector base amplitude panning triangulation;

FIG. 3 shows schematically a further vector base amplitude panning triangulation produced using a prior method;

FIG. 4 shows schematically an amplitude panning gain determiner according to some embodiments;

FIG. 5 shows a flow diagram of an example method of selecting a search method for a Loudspeaker triplet set according to some embodiments;

FIG. 6 shows a flow diagram of an example method of preparing a Loudspeaker triplet set for a search of the Loudspeaker triplet set according to some embodiments;

FIG. 7 shows a flow diagram of a further example method of preparing a Loudspeaker triplet set for a search of the Loudspeaker triplet set according to some embodiments;

FIG. 8 shows a flow diagram of an example method of assigning elevation ranges to a Loudspeaker triplet set according to some embodiments;

FIG. 9 shows a flow diagram of an example method of selecting a search method of a Loudspeaker triplet set for a target panning direction according to some embodiments;

FIG. 10 shows a flow diagram of an example method of searching a Loudspeaker triplet set for a target panning direction according to some embodiments;

FIG. 11 shows a flow diagram of a further example method of searching a Loudspeaker triplet set for a target panning direction according to some embodiments;

FIG. 12 shows schematically apparatus suitable for employing the methods of generating vector base amplitude panning triangulation according to some embodiments; and

FIG. 13 shows schematically an example device suitable for implementing the apparatus shown.

### EMBODIMENTS OF THE APPLICATION

The following describes in further detail suitable apparatus and possible mechanisms for the provision of adaptation of vector base amplitude panning (VBAP).

As discussed previously VBAP is based on three phases which typically comprise automatically triangulating a 3D loudspeaker setup, selecting an appropriate active triangle based on the direction (such that for a given direction three loudspeakers are selected which form a triangle where the given direction falls in), and computing gains for the three loudspeakers forming the particular triangle (or generally the particular polygon). The ‘active’ triangles may be generalized as being a virtual surface arrangement comprising virtual surfaces with corners located at loudspeaker or speaker node locations. Furthermore, although some embodiments hereafter describe the generation of virtual surfaces as triangle surfaces the same methods and apparatus may be employed for any suitable polygon surface.

For the purposes of understanding the description herein the following terminology is adopted. A loudspeaker may be also known by the following: speaker; speaker node and vertex. A virtual surface may be understood to be a sound surface represented within the 3D space defined by the speaker nodes. Triangulation may be referred to a process whereby the sound surface is divided up into a number of the same type of virtual surface shape in other words a virtual surface arrangement. The virtual surface shape (or virtual surface) may be one of triangle, tetragon, pentagon or a hexagon. The invention below is described in the terms of a triangle which may also be referred to by one of the following terms: virtual surface triplet; and loudspeaker triplet. In general, the embodiments below may be applicable to a virtual surface having any one of the shapes listed above.

In some embodiments the virtual surface arrangement may be divided into virtual surfaces of different shapes.

In broad terms the first phase of VBAP is typically performed during an initialization of the apparatus in which the VBAP gains and the loudspeaker triplets (for a plurality of azimuth and elevations values) are pre-formulated according to the loudspeaker setup of the system and then stored as a lookup table in memory. A real time process then performs the amplitude panning by locating from memory the appropriate loudspeaker triplet and corresponding loudspeaker gains for the desired panning direction (as given by an azimuth and elevation value).

An effective process for the triangulation of a 3D loudspeaker setup has been disclosed in the patent publication EP3541097. Moreover, the computation of the panning gains can also be computationally efficient once the correct loudspeaker triplet has been selected in accordance with a given azimuth and elevation value.

However previous solutions to the problem of determination of the correct loudspeaker triplet for a given set of direction parameters (azimuth and elevation) have been found to have some disadvantages. In essence two approaches can be taken namely: selection of the loudspeaker triplet during real time and a strategy which relies on the pre-calculation of the loudspeaker triplets.

In the case of selecting the correct triangle (or loudspeaker triplet) during real time, enough processing capacity has to be made available to select each potential loudspeaker triplet in turn and calculate the associated panning gains. For instance, a loudspeaker setup may comprise up to 22 individual triangles which may each have to be individually tested in order to determine the appropriate triangle for a given direction. The appropriate triangle is only identified as the triangle whose panning gains are all non-negative. Therefore, depending on the given direction, there is a requirement that the apparatus performing the rendering has sufficient computational power to test all individual triangles in real time. In some devices, such as mobile user terminals, this requirement may be too demanding and therefore it is preferable that an alternative strategy is used to select the specific loudspeaker triplet.

Alternatively, one solution would be to deploy a pre-calculation method whereby the triangles and panning gains are calculated for each possible combination of elevation and azimuth direction components during the initialization phase. However, this approach is particularly dependent on the resolution over which the direction components are searched. For instance, the triangles and gains may be pre-calculated for each possible degree resolution of direction components. This would not only result in a large table and hence memory for the storage of triangle values, but also require considerable processing power during the initialization phase. To overcome the problem of searching a large table of pre-calculated triangle values some solutions have adopted solutions from the world of computer graphics, such as the Kirkpatrick's point location algorithm. However, in this case (of having pre-calculated triangle values for each resolution of elevation) the use of the Kirkpatrick's point location algorithm would result in the requirement to store even more triangle values to implement the search structure. Alternatively, a more generic solution, such as a balanced binary tree search, would also not lead to the most efficient solution for traversing table/store of triangle values. This is due to the characteristic that the calculations used in the triangulation of the VBAP are inherently cyclic, which results in the suboptimal use of a binary search tree.

Embodiments herein overcome the above disadvantages by providing a solution which is both computationally efficient so that it can be used in the runtime selection of a triangle and requires less storage than traditional table based methods.

In embodiments the VBAP algorithm may determine an arrangement of sound surfaces, in which the arrangement of sound surfaces comprises a plurality of sound surfaces generated by having at least three speaker nodes of a plurality of speaker nodes. Each of the at least three speaker nodes is positioned in the three dimensional space in order to form a corner of a sound surface where any two sides of the sound surface is connected to a corner of the sound surface such that at least one defined sound plane does not intersect with the any two sides of the sound surface. A virtual surface as described hereafter may therefore be understood to be a sound surface represented within the 3D space defined by the speaker nodes.

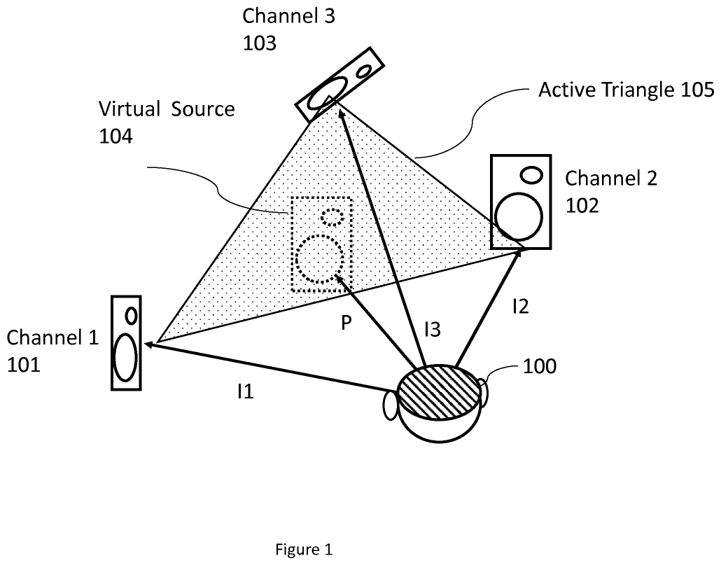

The first stage of VBAP is division of the 3D loudspeaker setup into triangles. An example ‘active’ triangle is shown in FIG. 1.

FIG. 1 shows for example three loudspeakers, channel 1 101 located at the direction of unit vector l₁, channel 2 102 located at the direction of unit vector l₂ and channel 3 103 located at the direction of unit vector l₃. These vectors are defined relative to the listener 100 at a point of origin and show the defined active triangle 105 defined by the three loudspeakers. Furthermore, is shown a virtual source 104 located at the direction of unit vector p relative to the listener 100 within the active triangle 105.

The next stage is to formulate panning gains corresponding to the panning directions.

In general Vector base amplitude panning refers to the method where three unit vectors l₁, l₂, l₃ form the triangle to which the panning direction falls.

The panning gains for the three loudspeakers are determined such that the three unit vectors are weighted so that the weighted sum vector points towards the desired amplitude panning direction. This can be solved as follows. A column unit vector p is formulated pointing towards the desired amplitude panning direction, and a vector g containing the amplitude panning gains can be solved by a matrix multiplication

$${g}^{T} = {{p}^{T} [ \begin{matrix}{l}_{1}^{T} \\ {l}_{2}^{T} \\ {l}_{3}^{T}\end{matrix} ]}^{- 1} .$$

where ⁻¹ denotes the matrix inverse. After formulating gains g, their overall level is normalized such that for the final gains the energy sum g^{T}g=1;

In order to perform the amplitude panning, VBAP needs to first triangulate the 3D loudspeaker setup. There is no single solution to the generation of the triangulation and the loudspeaker setup can be triangulated in many ways. In typical VBAP, the solution is to try to find triangles of minimal size (no loudspeakers inside the triangles and sides having as equal length as possible). In a general case, this is a valid approach, as it treats auditory objects in any direction equally, and tries to minimize the distances to the loudspeakers that are being used to create the auditory object at that direction.

To that end patent application EP3541097 discloses a method of triangulating a 3D multi-channel loudspeaker (virtual or otherwise) setups to produce an automatic adaptation of the vector base amplitude panning (VBAP) for arbitrary loudspeaker setups. The disclosure in patent application EP3541097 describes a triangulation scheme for VBAP that avoids triangles crossing any horizontal planes and in particular a horizontal plane at the elevation of 0 degrees.

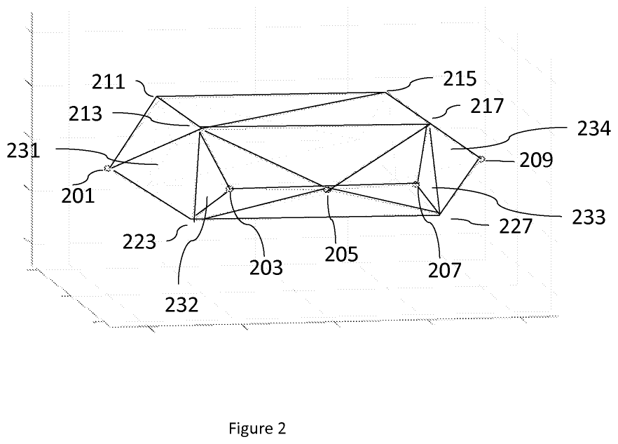

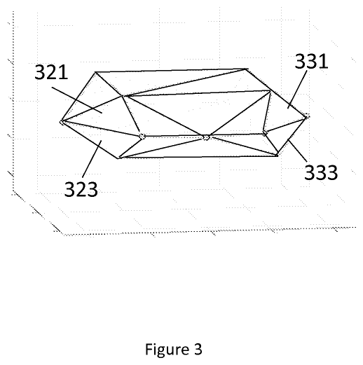

An example of such a triangular scheme can be seen by comparing FIG. 2 with FIG. 3. In FIG. 2 depicts a common loudspeaker set up in which 4 loudspeakers are added above the horizontal plane and 4 loudspeakers added below the horizontal plane of the 7.1 setup to give a 7.1+8 In the following example a full 3D setup is formed (loudspeakers both above and below the horizontal plane) by extending the common 7.1+4 setup by adding 4 loudspeakers also below the horizontal plane, resulting in the following positions for the loudspeakers:
Elevation 0 degrees, azimuth 0, ±30, ±90, and ±150 degrees, which may be defined as (0,0) 205, (30,0) 207, (90,0) 209, (150,0) not seen in FIG. 2, (−150,0) not seen in FIG. 2, (−90,0) 201, (−30,0) 203.
Elevation 30 degrees, azimuth ±45 and ±135 degrees, which may be defined as (45,30) 217, (135,30) 215, (−135,30) 211 and (−45,30) 213.
Elevation −20 degrees, azimuth ±45 and ±135 degrees, which may be defined as (45,−20) 227, (135,−20) not seen in FIG. 2, (−135,−20) not seen in FIGS. 2 and (−45,−20) 223.

This example loudspeaker setup is denoted as 7.1+8.

With such a setup a common (or default) VBAP triangulation scheme would create triangles which cross the horizontal plane such as 231, 232, 233 and 234. Whereas FIG. 3 shows an example triangulation produced by EP3541097 wherein the areas covered by triangles 231 and 232 are now represented by triangles 321 (with vertices/corners defined by loudspeakers (−90,0) 201, (−30,0) 203 and (−45,30) 213) and 323 (with vertices/corners defined by loudspeakers (−90,0) 201, (−30,0) 203 and (−45,−30) 223). Similarly, the areas covered by triangles 233 and 234 are now represented by triangles 331 (with vertices/corners defined by loudspeakers (90,0) 209, (30,0) 207 and (45,30) 217) and 333 (with vertices/corners defined by loudspeakers (90,0) 209, (30,0) 207 and (45,−30) 227).

As mentioned previously, embodiments herein proceed from the consideration that the next stage of the VBAP process is the determination of the correct loudspeaker triplet for a given set of direction parameters (azimuth and elevation). Whilst it has been discussed that solutions already exist for the selection of the correct loudspeaker triplet, there is a need to have a solution which takes advantage of the horizontal plane approach to triangulation of a loudspeaker setup as disclosed in EP3541097. Furthermore, this solution should be computationally efficient so that it can be used in the runtime selection of a triangle and require less storage than traditional based table methods. It is to be appreciated that the solutions described below may also provide a more efficient search methodology for loudspeaker setups deploying triangulation algorithms which allow loudspeaker triplets to cross a horizontal plane.

In EP3541097, one of the pre-steps before triangulation involves inspecting the loudspeaker (also known as speaker or speaker nodes) positions so that horizontal layers having a number of speakers can be identified. For example, 5 loudspeakers with elevation of 0° would form one horizontal layer at 0° elevation. If there are any horizontal layers present, then speakers can be divided to speaker subsets. Each subset contains all speakers that belong to the limiting horizontal layers and all speakers that have elevation angle between the range of the elevation angles of the limiting horizontal layers. Absolute elevation limits (usually −90° and) 90° can act as limiting elevation for a speaker subset even though it may not contain an actual speaker. For example, with two horizontal layers present (e.g., 0° and 30° elevation), there maybe be three speaker subsets (−90° to 0°, 0° to 30°, and 30° to 90° elevation). If there are no horizontal layers present, then there is one speaker set containing all the speakers. In some embodiments, the number or location of horizontal layers (and thus, speaker subsets) may be restricted. For example, a practical approach could use only a single subset-dividing horizontal layer at elevation 0°.

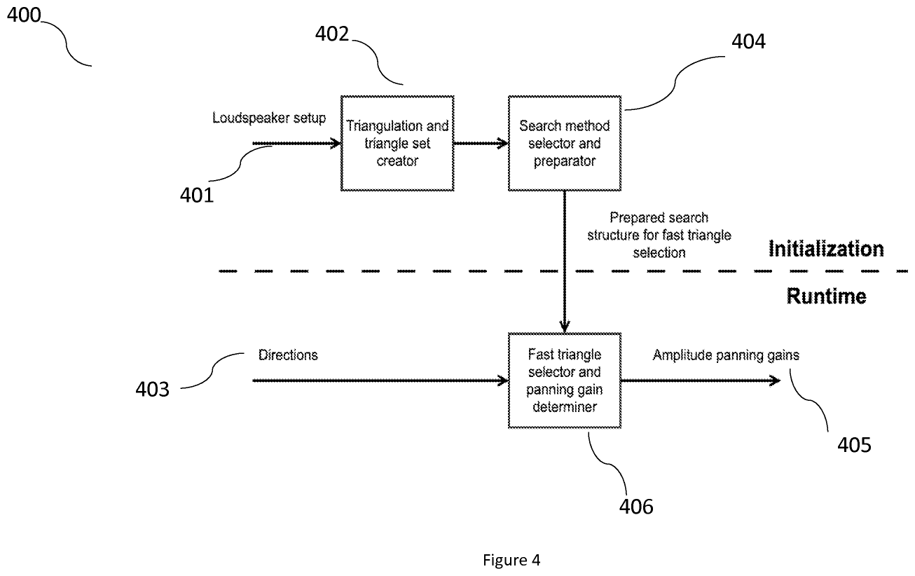

FIG. 4 discloses an amplitude panning gain determiner 400 which can implement the three stages of the VBAP process.

FIG. 4 depicts an input 401 indicating the particular setup of the loudspeaker system. For example, in the above loudspeaker setup of FIGS. 2 and 3 the input 401 may convey the loudspeaker configuration of 7.1+8. This input is passed to the function performing the Triangulation and triangle set creator 402. In embodiments the function 402 is configured to perform the triangulation of the loudspeaker setup as indicated by the input 401. In embodiments the Triangulation and triangle set creator 402 may perform its functionality according to the processes outlined in the patent application EP3541097. The output from the Triangulation and triangle set creator 402 can be in some instances a single set of loudspeaker triplets (triangles of the 3D loudspeaker virtual surface) or in other instances for the loudspeaker setup the output may comprise multiple subsets of loudspeaker triplets. The set/subsets of loudspeaker triplets may be passed to the Search method selector and preparator 404. Broadly speaking the search method selector and preparator 404 is arranged to select a suitable search method for each set/subsets of loudspeaker triplets and prepare the format (or structure) of the set/subsets of loudspeaker triplets for an efficient selection of the most appropriate loudspeaker triplet. The output from 404 is the “prepared” set/subsets of loudspeaker triplets which may comprise a data structure comprising loudspeaker setup information, prepared triangulation, prepared loudspeaker triplet sets and information supporting the search. Also shown in FIG. 4 is the indication that the processes performed by the functions 402 and 404 may be performed at a set up/initialization phase of a renderer/decoder. In other words, it is expected that the processes performed by the functions 402 and 404 are performed before there is real time processing of the audio data. However, there may be some operating instances in which the functions of 402 and 403 are performed during runtime. These operating instances may include cases when the loudspeaker set up is not known before the first encoded frame is processed. Therefore, for these cases it may be required to perform the initialization during the processing of the first audio frame. Following on from this, the “prepared” set/subsets of loudspeaker triplets may then be used during the runtime phase of operation of the amplitude panning gain determiner 400. The runtime phase of operation is depicted in FIG. 4 as the function fast triangle selector and panning gain determiner 406. This function takes the structure of “prepared” set/subsets of loudspeaker triplets and performs a fast search of each set/subset of loudspeaker triplets for each input direction parameter 403. The output from the function 406, for each input direction parameter 403, is the amplitude panning gains 405 corresponding to the loudspeaker triplet selected for the direction parameter 403.

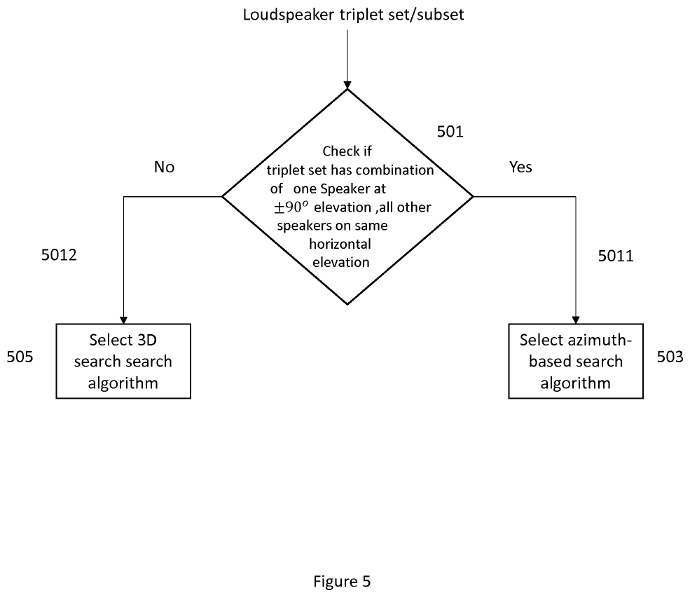

From FIG. 4, the stage following the triangulation of the loudspeaker setup is termed the search method selector and preparator 404. In that respect FIG. 5 depicts a flow chart for the selection of the optimal search method for the loudspeaker triplet set/subset. As mentioned above, the first stage of the VBAP process comprises the triangulation of the loudspeaker setup. This results in a set or subsets of loudspeaker triplets which is particular to the loudspeaker setup.

Initially the optimal search method selection process of FIG. 5 may be configured to check the variant or composition of the loudspeaker triplet set/subset. In this respect FIG. 5 is depicted as checking whether the loudspeaker triplet set/subset falls into one of two variants. The first variant of loudspeaker triplet may be viewed as a special case comprising the constraint of one speaker at either +90° or −90° elevation with all the other speakers residing on the same horizontal layer. In other words, all the other speakers may have the same value of elevation. For example, this type of variant may have one speaker at −90° elevation and another 5 speakers positioned on a horizontal plane at an elevation of 0 degrees. The second variant may be viewed as the generic case (or default case), in which the loudspeaker setup does not satisfy the above constraint.

The checking step is shown in FIG. 5 as 501 in which the constraint is checked if the loudspeaker setup having the arrangement of one of the speakers at an elevation value of either +900 or −90° with the other remaining speakers at the same elevation value. If this constraint is met, then the decision branch 5011 for the special case is taken. Otherwise, the process selects the branch 5012 for the generic (or default) case.

The selection of the above special case (decision branch 5011) leads to the decision to use a specific algorithm (shown as step 503) for the subsequent search of the loudspeaker triplet set/subset (to be performed in 406). The azimuth search-based algorithm is selected for cases in which each azimuth value is associated with a single loudspeaker triplet within the set of loudspeaker triplets. This occurs when the above constraint is met, that is having an arrangement of one speaker at an elevation value of either +90° or −90° and all other speakers at the same elevation value. The decision to use the azimuth-based search method may either accompany the loudspeaker triplet set or is simply stored at a location which may be accessed by subsequent steps of the VBAP process.

The selection of the generic case (decision branch 5012) leads to the decision to use a more general method of searching the loudspeaker triplet set/subset shown for those loudspeaker setups which do not meet the above criteria. In this case the full 3D search method of the loudspeaker triplet set/subset is selected for use in the fast triangle selector 406. This is shown as step 505 in FIG. 5. The decision to use the generic 3D search method may either accompany the loudspeaker triplet set/subset or is simply stored at a location which may be accessed by subsequent steps of the VBAP process.

In the case of when the triangulation process 402 results in several loudspeaker triplet subsets (rather than a single loudspeaker triplet set) the processing steps of FIG. 5 are then repeated for each of the loudspeaker triplet subsets.

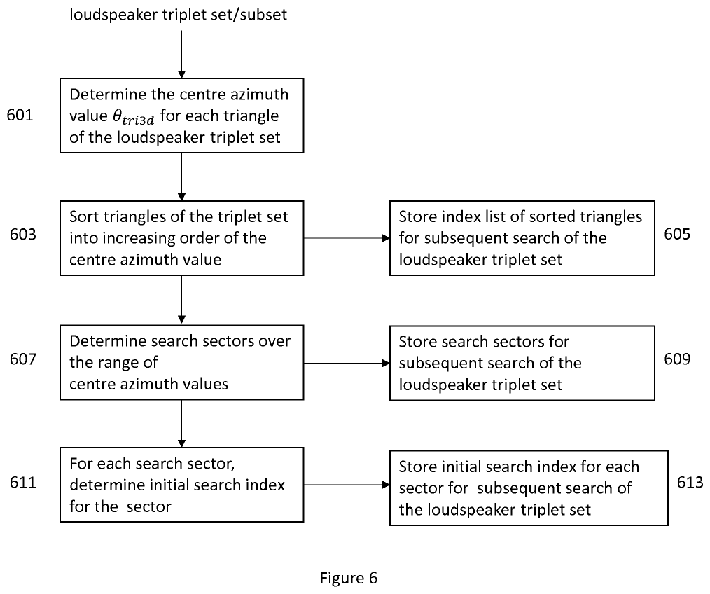

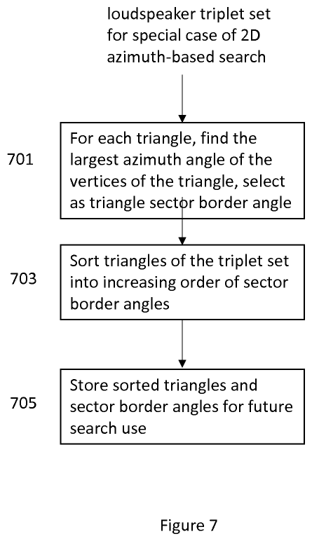

After the method of searching the loudspeaker triplet set/subset has been determined, the functional block 404 performs a preparatory step where the structure of the loudspeaker triplet set/subset is prepared for fast searching during the runtime phase. To that end FIG. 6 shows the steps involved in preparing a loudspeaker triplet set/subset for the subsequent generic 3D search method, and FIG. 7 shows the processing steps involved in preparing the loudspeaker triplet set for the subsequent specific azimuth-based search method. To be clear the preparatory steps of FIGS. 6 and 7 are performed as part of the initialization phase function of 404.

Turning to FIG. 6, the process starts by taking the loudspeaker triplet set/subset. Then, for each loudspeaker triplet finding a “centre” vector and calculating the angle of the “centre” vector projected onto the x-y plane. This in effect gives the azimuth of the “centre” vector.

The “centre” vector of a loudspeaker triplet (or triangle) may be calculated by determining the resolved vector (or vector sum) of the three vectors which point to the vertices (or loudspeakers) of the loudspeaker triplet. The azimuth is therefore the angle of this vector projected onto the x-y plane. The “centre” azimuth value of a loudspeaker triplet θ_{tri3d} may be expressed as

$${θ}_{tri 3 d} ( i ) = a tan ( \frac{{\sum }_{n = 1}^{3} {y}_{n} ( i )}{{\sum }_{n = 1}^{3} {x}_{n} ( i )} ) for all i$$

The index i in the above expression is the index of a triangle in the loudspeaker triplet set/subset. The above expression is performed for all triangles in the loudspeaker triplet set/subset.

The three vectors which define the loudspeaker triplet (or triangle) by pointing to each loudspeaker defining the triplet (or triangle) i are given as

$${\vec{v}}_{1} ( i ) = [ \begin{matrix}{x}_{1} ( i ) \\ {y}_{1} ( i ) \\ {z}_{1} ( i )\end{matrix} ] , {\vec{v}}_{2} ( i ) = [ \begin{matrix}{x}_{2} ( i ) \\ {y}_{2} ( i ) \\ {z}_{2} ( i )\end{matrix} ] and {\vec{v}}_{3} ( i ) = [ \begin{matrix}{x}_{3} ( i ) \\ {y}_{3} ( i ) \\ {z}_{3} ( i )\end{matrix} ]$$

Note, it is assumed that the above arctan function solves the expression for the correct quadrant based on the signs of the nominator and denominator.

As mentioned above this calculation is performed for each loudspeaker triplet (or triangle) of the loudspeaker triplet set and is shown as the processing step 601 in FIG. 6.

The next stage of the generic 3D preparatory process for the loudspeaker triplet set/subset involves ordering the triangles of loudspeaker triplet set/subset into an increasing order of azimuth angle. This may be performed by known sorting means. In practice this step may involve simply changing the order of the triangle indices of the loudspeaker triplet set. The resultant from this processing step may be a new ordered list of indices, where is represents a triangle index of the ordered list. This step is shown as the processing step 603 in FIG. 6. Also shown in FIG. 6 is the operation of storing the sorted triangles for future use in the rapid search performed by 406. This step is shown as the processing step 605 in FIG. 6. In practice this step may involve storing an array of loudspeaker triplet structures in their sorted order, where a loudspeaker triplet structure comprises the indices of the loudspeakers (or speaker nodes) that form the loudspeaker triplet.

The next stage of the generic 3D preparatory process is to form a number of non-overlapping search sectors which cover the full range of azimuth values. Basically, this step involves dividing the azimuth into a number of sectors with each section being assigned to a specific range of azimuth values. For instance, in one example embodiment the 360° range of azimuth values may be divided into 4 equally spaced non overlapping sectors comprising 0° to 89°, 90° to 179°, 180° to 269°, and 270° to 359°, assuming that the azimuth values are considered in integer precision. It is to be appreciated that other division ratios may be used. For instance, the sectors need not all be the same. In such embodiments each range of a sector may be proportional to the distribution of triangles within the loudspeaker triplet set. In other words, regions of the azimuth angle range which have a larger number of triangles may be divided into a larger number of sectors with each sector having a smaller granularity than regions of the azimuth angle which have smaller number of triangles. For example, one embodiment may comprise dividing the azimuth range into a number of sectors where each sector can have a substantially equal number of loudspeaker triplets. Once the sectors are formed the azimuth angle of the border/edge of each sector may be noted and stored for future use. Border value for each sector may be stored as θ_{border3d}(j) where j is the index of the sector with there being J sectors in total. For instance, taking the above example of the azimuth angle range being divided into 4 sectors, the border value for each sector may comprise the upper value of the sector θ_{border3d}(0), θ_{border3d}(1), θ_{border3d}(2), θ_{border3d}(3)=[90°, 180°, 270°, 360°]. Alternatively, some embodiments may deploy a border value which uses the lower value for each sector, such as [0°, 90°, 180°, 270°]. Alternatively, some embodiments may deploy border values which contain both the lower and the upper values.

However, in some embodiments it may not be required to store the above border values. Instead, the border values of each sector may be implied by adopting a scheme in which the number of sectors is known, and the range of each sector is divided evenly over the total range of azimuth angles.

One C-code implementation may take the form of

```
if ( abs( azi_deg ) > 90 )
{
  quadrant = azi_deg < 0 ? 2 : 1;
}
else
{
  quadrant = azi_deg < 0 ? 3 : 0;
}
```

In this case the azimuth values are between −180 and 180 degrees.

The processing step of forming sectors over the range of azimuth angles is shown as 607 in FIG. 6, and the step of storing the border/edge of each sector is shown as the processing step 609.

Once the sectors have been defined the preparatory process for the fast 3D search method goes onto determining an initial search index ζ(j) for each search sector j. In embodiments this may be performed first by determining a reference angle ρ(j) for each search sector j. In embodiments the reference angle ρ(j) for a sector j may be the mid-point angle of the search sector. For instance, using the above example where the first search sector ranges from 0° to 89°, the reference angle ρ(0) may be set to 45°. Finally, for each of the J reference angles (and therefore for each search sector), a triangle is assigned from the sorted list of loudspeaker triplets (as derived in step 603). In embodiments the assigned triangle may be the triangle (from the sorted list) having a triangle centre (azimuth) angle θ_{tri3d} closest to the reference angle ρ(j). The sorted triangle index is, of the closest triangle to the reference angle ρ(j) may then be assigned as the initial search index ζ(j) for the search sector j, that is ζ(j)=i_{s,j}. Where i_{s,j} is the index of the triangle whose triangle centre (azimuth) angle θ_{tri3d} closest to the reference angle ρ(j).

The step of determining an initial search index ζ(j) for the sector j is shown for all sectors J as the processing step 611 in FIG. 6. The operation of storing the initial search sector indices for future use is shown as the processing step 613 in FIG. 6.

Turning to FIG. 7 where the preparatory process for the special case 2D azimuth-based search is shown. The process takes as an input the loudspeaker triplet set which has been selected by the process of FIG. 5 for the special case 2D azimuth-based search.

The process commences by determining the azimuth angle for two vertices (or loudspeaker positions) of each triangle in the set. That is for each triangle the azimuth angle of two vectors each pointing to a vertex of a triangle is determined. As explained previously, the positions of the loudspeakers for the azimuth-based search are all on one horizontal plane except for one (virtual or real) loudspeaker which is positioned at an elevation of ±900. Therefore, this means that all triangles of the special case 2D azimuth-based search will have at least one vertex at an elevation of at ±90°. Consequently, only two azimuth angles are calculated for each triangle.

For example, in embodiments the azimuth angle of say a first vertex of a triangle is given by

$${θ}_{tri 2 d} = a tan ( {y}_{1} / {x}_{1} )$$

where it is assumed that the arctan function solves the expression for the correct quadrant based on the signs of the nominator and denominator, where the vector pointing to the first vertex of a triangle is given as

$${\vec{v}}_{1} = [ \begin{matrix}{x}_{1} \\ {y}_{1} \\ {z}_{1}\end{matrix} ]$$

This is repeated for either one of the other two vectors \vec{v}₂ or \vec{v}₃, each pointing to their respective second and third vertices of the triangle.

The largest azimuth angle is then selected for the triangle and is marked as the sector border angle θ_{border2d}(j), where as before j denotes the index of the search sector.

This may then be repeated for all triangles in the loudspeaker triplet set selected for the special case search.

For example, using the bottom half of the 7.1+8 loudspeaker setup of FIG. 2. There are horizontal speakers at 0, 30, 90, 150, −150, −90, and −30 degrees (the elevation is 0 degrees for all of these). Additionally, there is one virtual loudspeaker at −90 degrees of elevation.

So, the first triangle would be between the nodes (0, 0), (30, 0), and (0,−90) in the form of (ϕ, θ) The second triangle would be between the nodes (30, 0), (90,0), and (0,−90). The third triangle would be between the nodes (90, 0), (150,0), and (0,−90) and so on. Resulting altogether in seven triangles covering the bottom half of a virtual sphere.

So, in this example the sector border angles θ_{border2d}(j) would be 30, 90, 150, 210, 270, 330 and 360 degrees for j=0 to 6.

As noted earlier for the special 2D azimuth-based search there is a ratio of 1:1 for of search sector to loudspeaker triplet/triangle.

One final point. A special case exists when one of the vertices of the triangle has an azimuth angle of 0°. If this is found to be the case, then if the other triangle vertex has an azimuth angle which is greater than 180°, the sector border angle for this triangle is marked as 360°. However, should the other triangle's vertex be found to have an azimuth which is less than 180°. Then this value of the azimuth angle is selected as the sector border angle for the triangle.

The step of finding the largest azimuth angle for each triangle of the loudspeaker triplet set is shown as processing step 701 in FIG. 7.

The next stage of the preparatory process for the azimuth-based search involves ordering the triangles of the loudspeaker triplet set in terms of the increasing order of sector border angles ζ_{border2d}(j). This is shown as processing step 703 in FIG. 7.

Finally, the reordered triangles of the loudspeaker triplet set are stored along with their respective sector border angles for future use. This is shown as the processing step 705 in FIG. 7.

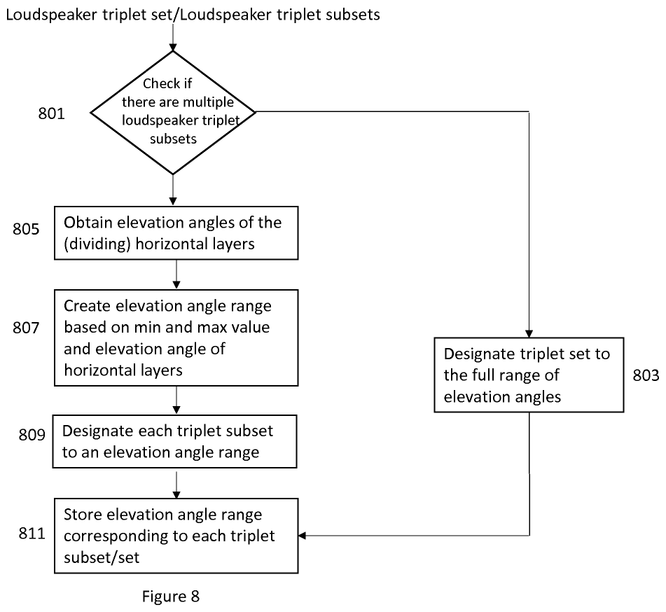

Additionally, in embodiments the preparatory processes as performed by the function 404 may comprise a further process in which each loudspeaker triplet set/subset is assigned to a range of elevation values. Such a process is shown in FIG. 8, where it can be seen the first step checks whether the loudspeaker setup has either multiple horizontal layers of loudspeaker nodes or a single horizontal layer of loudspeaker nodes. This is shown as the step 801 in FIG. 8. If step 801 determines that there is only one horizontal layer of loudspeaker nodes the process proceeds to step 803 which marks the loudspeaker triplet set as occupying the full range of possible elevation angle values from −90° to +900. However, if step 801 indicates that the loudspeaker setup comprises multiple horizontal layers of loudspeaker nodes the process may proceed to step 805. At step 805 the elevation of each horizontal layer (of loudspeaker nodes) is obtained for the loudspeaker setup.

At step 807 a range of elevation values may then be formed. In embodiments this may take the form of either creating the range of elevation values between a maximum possible value (e.g. +90 degrees) and the elevation value of the horizontal layer of the loudspeaker triplet subset, or creating the range of elevation values between the elevation values of two horizontal layers, or creating the range of elevation values between the elevation value of the horizontal layer of the loudspeaker triplet subset and a minimum possible value (e.g. −90 degrees). The actual bounds of the range of elevation values may be dependent on the elevation of the horizontal layer of the loudspeaker triplet subset. A first elevation range, associated with the lowest elevation horizontal layer, may be formed as the range of values from the minimum elevation value to the elevation value of the first horizontal layer. A second elevation range, associated with a higher elevation horizontal layer than the first horizontal layer, may be formed as the range of elevation values between the elevation value of the first horizontal layer and the elevation value of the second horizontal layer. If the second horizontal layer is the highest elevation value then a final (third) range of elevation values may be formed between the elevation value of the second horizontal layer and the maximum elevation value. In general, there are n+1 elevation ranges, where “n” is the number of horizontal layers according to the loudspeaker setup. The number of elevation ranges determines the number of loudspeaker triplet subsets. For example, in this case there will be three loudspeaker triplet subsets in which the first loudspeaker triplet subset has triangles whose elevation values lie from the maximum elevation value to the elevation value of the first horizontal layer. The second loudspeaker triplet subset has triangles whose elevation values lie from the elevation value of the first horizontal layer to the elevation value of the second horizontal layer. The third loudspeaker triplet subset has triangles whose elevation values lie from the elevation value of the second horizontal layer to the maximum elevation value.

The above process as performed by step 807, may be further clarified by way of the following example where there is a loudspeaker setup with horizontal layers at elevation 0° and at elevation 30°. In this example, step 807 results in the partitioning of the elevation values into three loudspeaker triplet subsets of ranges;
1. −90° (range end point) to 0° (horizontal layer),
2. 0° (horizontal layer) to 30° (horizontal layer), and
3. 30° (horizontal layer) to 90° (range end point).

At step 809 the triangles (loudspeaker triplets) from the triangulation process may be apportioned into a loudspeaker triplet subset in accordance with the elevation value of each loudspeaker triplet and the range of elevation values of the loudspeaker triplet subset. In effect each loudspeaker triplet is assigned to a loudspeaker triplet subset when the elevation value of the loudspeaker triplet lies within the range of elevation values given to the loudspeaker triplet subset.

Finally FIG. 8 depicts the step 811 in which elevation angle range for each loudspeaker triplet set/subset is stored for use in the function 406.

Turning to the runtime phase of the VBAP process which as previously mentioned can be performed by the fast triangle selector and panning gain determiner 406. The first process of the runtime phase involves taking in the obtained target panning direction (the direction parameters elevation and azimuth) and assign them to a suitable loudspeaker triplet set/subset. In embodiments this may take the form of marrying the loudspeaker triplet set/subset whose allocated range of elevation values encompasses the elevation value of the target panning direction, and then checking whether the selected loudspeaker triplet set/subset is of generic 3D search method or the special case 2D azimuth-based search method.

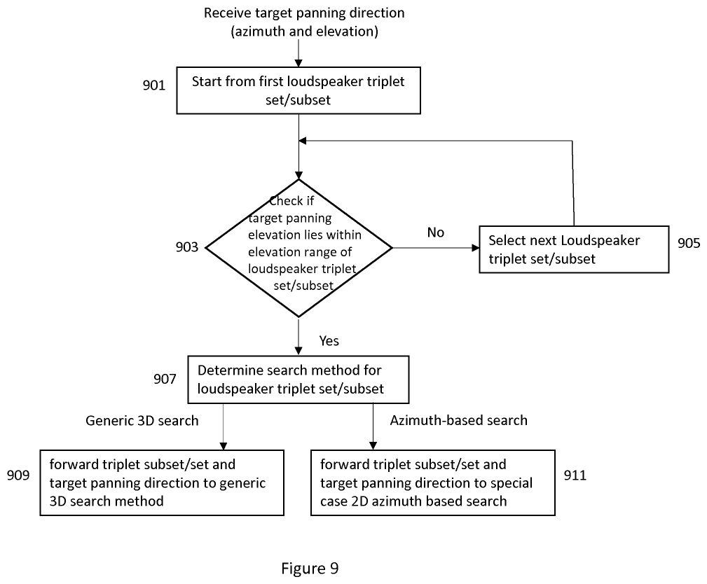

FIG. 9 depicts a process which is arranged to perform the above functionality. The process receives a target panning direction parameter comprising azimuth and elevation values. The process starts by taking the first loudspeaker triplet set (Step 901) and then perform a check to determine if the elevation value of the target panning direction parameter lies within the range of elevations values of the (first) loudspeaker triplet set/subset (step 903). If the elevation value of the target panning direction parameter does not lie within the range of elevations values of the (first) loudspeaker triplet set/subset the process loops back and selects the next loudspeaker triplet set to check (step 905). However, if the result of the above check (step 903) returns the indication that the elevation value of the target panning direction parameter lies within the range of elevations values of the loudspeaker triplet set/subset the process then proceeds to step 907 where the method of search is allocated for the loudspeaker triplet set/subset is. If it is determined that the loudspeaker triplet set/subset is associated with the generic 3D search method, then the loudspeaker triplet set/subset together with the target panning direction value is forwarded to the generic 3D search method of searching the loudspeaker triplet set/subset (step 909). Alternatively, if it is determined at step 907 that the loudspeaker triplet set/subset is associated with the special case 2D azimuth-based search, then the loudspeaker triplet set/subset together with the target panning direction value is forwarded to the 2D azimuth-based method of searching the loudspeaker triplet set/subset (step 911).

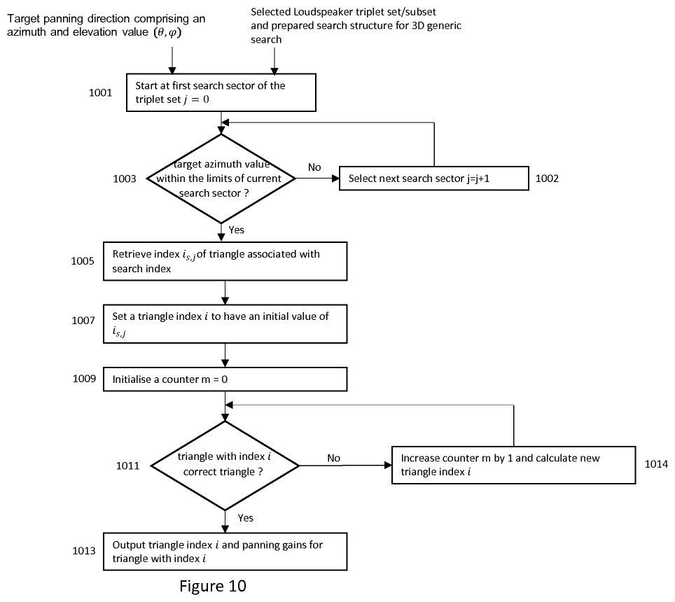

FIG. 10 is a flow diagram of the fast “generic” 3D search method which can be implemented by the functional block 406 as part of the VBAP process. FIG. 10 can be viewed as a process for deciding which loudspeaker triplet from the loudspeaker triplet set/subset encloses the target panning direction. As alluded to above the fast 3D search method takes the following as inputs; the target panning direction comprising an azimuth and elevation value (θ, φ), the prepared search structure according to the flow diagram of FIG. 6 and the selected sorted loudspeaker triplet set according to the flow diagram of FIG. 9. It may be recalled from the description accompanying FIG. 6 that the prepared search structure for the fast generic 3D search procedure comprises a loudspeaker triplet set/subset of triangles which have been arranged in an increasingly order of the triangle centre azimuth angle θ_{tri3d}, and the initial search index structure ζ(j) for each search sector j (in total there are J search sectors 0≤j<J). Each initial search index structure ζ(j) has member data items comprising; an index of a triangle i_{s,j} from the ordered loudspeaker triplet set of triangles and a parameter specifying the borders of the search sector ζ_{border3d}(j).

The 3D search method starts at the first search sector (j=0) where it is determined whether the target panning direction azimuth value θ is within the limits of the azimuth value of the first search sector. This may be checked by inspecting the search sector border value θ_{border3d}(j). If it is determined that the target panning direction azimuth value θ is not within the limits of the search sector j the process loops back to select the next search sector (j=j+1). This checking loop is shown in FIG. 10 by the processing steps 1001, 1002 and 1003.

If on the other hand it is determined that the target panning direction azimuth value lies within the boarder limits of the current search sector j at step 1003. The process is then configured to move to the next step 1005 where the triangle index i_{s,j} associated with the current search sector j is retrieved from the initial search index structure ζ(j).

The process is then arranged to set a triangle search index i based on the retrieved triangle index i_{s,j}. This is shown in FIG. 10 by the initialisation step of 1007.

The process may be configured to perform a search of triangles which lie either side if the retrieved triangle index i_{s,j}. This may be performed with a counter m which is configured to both increment and decrement the index i (by each increment of m) such that a triangle which has an index incrementally higher than i_{s,j} is able to be searched followed by a triangle which incrementally lower than i_{s,j}. In embodiments the index i may take the form of

$$i = mod ( {i}_{s , j} + floor ( \frac{m + 1}{2} ) * {( - 1 )}^{m} , N ) ,$$

where N is the number of triangles in the triangle set and mod is a modulo function, and where the counter m is used to regulate the number of triangles searched either side of the retrieved triangle index i_{s,j}. For example, the first five or so searches of triangles may follow the indexing pattern of (i, i−1, i+1, i−2, i+2, . . . ) for m 0 to 4, where i is initialised to i_{s,j}

Returning to FIG. 10, initialisation of the counter m is shown as processing step 1009.

The next stage involves determining whether the current triangle i is the correct triangle. In embodiments this may be determined by solving the equation from earlier of

$${g}^{T} = {{p}^{T} [ \begin{matrix}{l}_{1}^{T} \\ {l}_{2}^{T} \\ {l}_{3}^{T}\end{matrix} ]}^{- 1} .$$

And checking whether the three gain components of the VBAP panning gain vector g are all non-negative. The vector p is determined from the target panning direction azimuth and elevation value (e, q), where p=[x, y, z]

and x=cos θ*cos φ, y=sin θ*cos φ and z=sin φ. The vectors l₁, l₂, l₃ are the unit vectors pointing towards the three loudspeakers for the current triangle i.

The triangle i which yields a gain vector having three non-negative components is determined as the correct triangle for the input target panning direction. At this point the process will stop and output the index i as the correct triangle for the target panning direction. Additionally, the process also outputs the panning gains gᵢ for the triangle i (these gains are given as a side product of the above calculation step.)

Returning to FIG. 10 the above checking step is shown as the processing step 1011, and the step of outputting the correct triangle index and panning gains is shown processing step 1013. In other words, the correct triangle index is the index of the loudspeaker triplet/triangle which encloses the target panning direction, such that the target panning direction lies within the selected loudspeaker triplet or the target panning direction lies on the border between the selected virtual surface and the next virtual surface.

However, if it is determined at step 1011 that the VBAP panning gain vector g are not all non-negative then it is deemed that the triangle given by the index i is not the correct triangle for the input target panning direction. In this case the process determines the next triangle index by increasing the counter m by one and using the above expression for calculating a new value of i based on m and i_{s,j}. This is shown as the processing step 1014 together with the feedback loop to the checking step 1011.

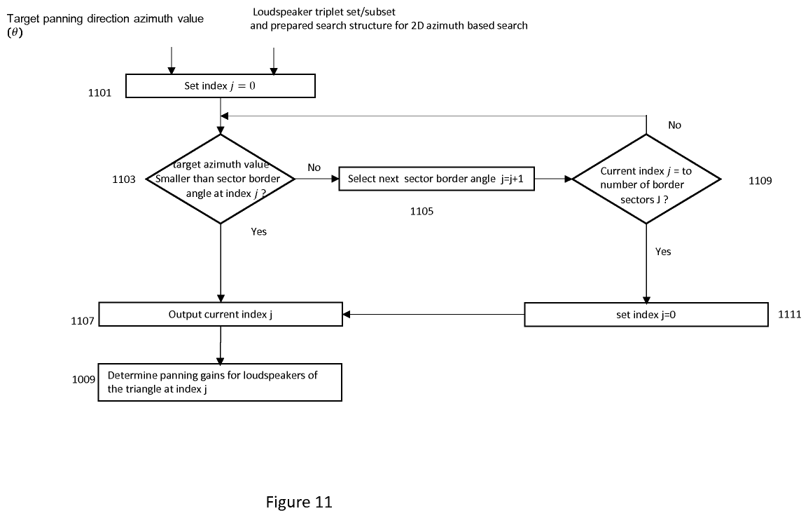

FIG. 11 is a flow diagram of the fast 2D azimuth-based search method which can also be implemented by the functional block 406 as part of the VBAP process. FIG. 11 can be viewed as a process for deciding which loudspeaker triplet from the loudspeaker triplet set encloses the target panning direction. As alluded to above the fast 2D azimuth-based search method takes the following as input; the target panning direction azimuth (0) value, the prepared search structure as described by the flow diagram of FIG. 7 and the selected loudspeaker triplet set from the flow diagram of FIG. 9. It may be recalled from the description accompanying FIG. 7 that the prepared search structure for the fast 2D azimuth-based search procedure comprises a loudspeaker triplet set/subset of triangles which have been arranged in an increasingly order of the sector border angles ζ_{border2D}(j) and the sector border angles themselves. Note in the case of the 2D azimuth-based search there is a one-to-one mapping of triangles in the loudspeaker triplet set/subset to sector border angles.

As shown in FIG. 11 the process receives the target panning azimuth angle and the prepared search structure comprising the ordered triangle list and the corresponding sector border angle for each ordered triangle.

The first stage of the process involves setting an index j to 0, this index is used to index through the sector border angles θ_{border2D}(j) one by one. This is shown as processing step 1101.

Next a checking step 1103 is performed which determines whether the target azimuth angle θ is less than the sector border angle θ_{border2D}(j) for the current index j. Each time the check determines that target azimuth angle θ is greater than the sector border angle θ_{border2D}(j) the process loops around via the step 1105 and the next sector border angle is tested. The step 1105 simply increases the index by one so that the next sector border angle may be checked by step 1103.

Basically, the steps 1103 and 1105 step through the increasingly ordered list of sector border angles until the azimuth angle is less than the current sector border angle. The index associated with this sector border angle is the index of the triangle which is closest to and encloses the target panning azimuth direction θ. The index of this triangle is then outputted from the loop (step 1107). In other words, the triangle index is the index of the loudspeaker triplet/triangle which encloses the target panning direction for the 2D search.

The loopback also comprises a check to determine whether the current index has reached the number of search sectors (J). In this case the target azimuth direction is greater than the highest ordered search sector and the output index of the selected triangle is set to zero. This is shown as the processing steps 1109 and 1111 in FIG. 11.

Finally, the panning gains can be determined using the target panning direction azimuth and elevation value (θ, φ) and the unit vectors pointing towards the three loudspeakers for the triangle associated with the outputted index from the process.

It is to be understood that in some embodiments there may be no special azimuth-based method of searching the loudspeaker triplet set. In such embodiments only the generic 3D method is used to the loudspeaker triplet set subset. In these embodiments the processes according to FIG. 5, FIG. 7 and FIG. 11 will not be implemented. Furthermore, with respect to FIG. 8 the processing path leading to the step 803 may not be implemented along with processing steps 907 and 911 from FIG. 9.

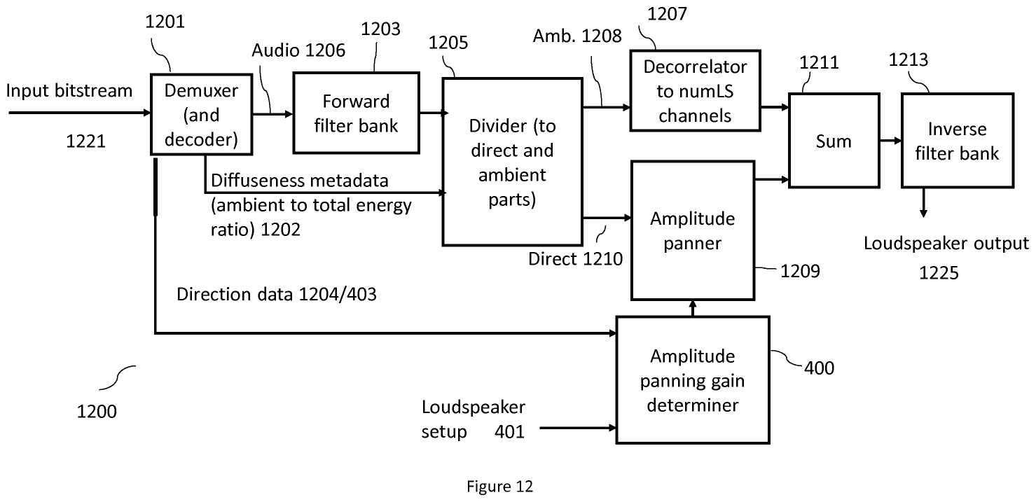

An example implementation of the embodiments described above is shown in FIG. 12 which shows an example system decoder and renderer. The example decoder and renderer may be configured to transmit one or two audio channels and spatial metadata. The spatial metadata involves at least a directional parameter in frequency bands and a ratio metadata in frequency bands, where the ratio (or diffuseness) parameter expresses if the sound at the frequency band is directional or ambience, or something in between.

The decoder 1200 is shown comprising a demuxer and decoder 1201 configured to receive an input bit stream 1221 (from any origin, for example, spatial sound captured, encoded and transmitted by a smartphone). The demuxer and decoder 1201 is configured to separate the bit stream 1221 into an audio signal 1206 component, and spatial metadata such as a diffuseness metadata 1202 component (which defines an ambient to total energy ratio) and direction metadata 1204 component.

The audio signals within the audio component 1206 are received by a forward filter bank 1203 which (may be complex-modulated low-delay filterbank) configured to transform the audio signals into frequency bands.

The frequency band audio signals may then be received by a divider 1205. The divider 1205 may furthermore receive the diffuseness metadata component 1202 and divide the frequency band signals into direct 1210 and an ambient 1208 (or diffuse) parts, for example by applying multipliers to the audio signals as a function of the ratio/diffuseness metadata in frequency bands.

The ambience (or diffuse) part 1208 may be received by a decorrelator 1207 which is configured to decorrelate the ambience part 1208 to generate a multi-channel spatially incoherent signal.

An amplitude panning gain determiner 400, such as described above with respect to FIG. 4 may be configured to receive the loudspeaker setup information 401 and is configured to perform triangulation of the 3D loudspeaker set up and prepare the resulting loudspeaker triplet sets for rapid search during the runtime phase of the operation. The runtime phase of 400 then proceeds to generate the generate the panning gains and correct triangle from the direction data 1204/403 for the amplitude panner 1209.

The direct part 1210 may be received by an amplitude panner 1209. The amplitude panner 1209 may furthermore receive the amplitude panning gains from the amplitude panning gain determiner 400. The direct part 1210 audio signals may then be amplitude panned in frequency bands according to the direction metadata, utilizing the amplitude panning gains generated with the present invention.

A sum module 1211 may be configured to receive the direct amplitude panned output from the amplitude panner 1209 and the multi-channel spatially incoherent signal from the decorrelator 1207 and generate a combined multi-channel signal.

An inverse filter bank 1213 may then be configured to receive the combined signal and generate a suitable multi-channel loudspeaker output 1225.

In some embodiments the azimuth-based 2D search may be adapted for an elevation range having two horizontal layers of speaker nodes which are directly above each other. In this case the azimuth angles of the speaker nodes would be identical on each horizontal layer and therefore the sector border angles θ_{border2D} need only be determined for one of the layers. Consequently, during the runtime phase two possible loudspeaker triplets would be produced for each sector. The correct loudspeaker triplet may be determined by the solving the equation

$${g}^{T} = {{p}^{T} [ \begin{matrix}{l}_{1}^{T} \\ {l}_{2}^{T} \\ {l}_{3}^{T}\end{matrix} ]}^{- 1} .$$

In practice, if the first triplet turns out to be not correct (a consequence of solving the above equation, then the triplet with the next index may be selected which may be verified using the above equation.

With further to the azimuth-based 2D search. The search methodology can be extended to cover a loudspeaker setup in which all the loudspeakers are situated on purely as horizontal layers.

With respect to the generic 3D search method described above it was found that having up to four azimuth search sectors offered an advantageous solution for the IVAS coding system. The number of search sectors may be tailored to different coding systems in accordance with a trade off between limiting the number of triplets to check and the extra memory required during runtime.

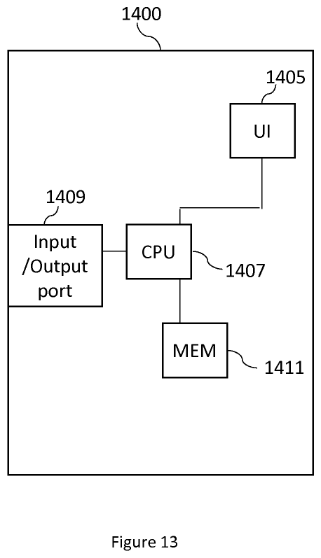

With respect to FIG. 13 an example electronic device which may be used as the analysis or synthesis device is shown. The device may be any suitable electronics device or apparatus. For example, in some embodiments the device 1400 is a mobile device, user equipment, tablet computer, computer, audio playback apparatus, etc.

In some embodiments the device 1400 comprises at least one processor or central processing unit 1407. The processor 1407 can be configured to execute various program codes such as the methods such as described herein.

In some embodiments the device 1400 comprises a memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore, in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407. In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example, the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating with the position determiner as described herein.

In some embodiments the device 1400 comprises an input/output port 1409. The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example, in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 1409 may be configured to receive the signals and in some embodiments determine the parameters as described herein by using the processor 1407 executing suitable code. Furthermore, the device may generate a suitable downmix signal and parameter output to be transmitted to the synthesis device.

In some embodiments the device 1400 may be employed as at least part of the synthesis device. As such the input/output port 1409 may be configured to receive the downmix signals and in some embodiments the parameters determined at the capture device or processing device as described herein and generate a suitable audio signal format output by using the processor 1407 executing suitable code. The input/output port 1409 may be coupled to any suitable audio output for example to a multichannel speaker system and/or headphones or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus for spatial audio signal decoding and rendering associated with a plurality of speaker nodes placed within a three dimensional space having virtual surface arrangement comprising a plurality of virtual surfaces, wherein each of the plurality of virtual surfaces has corners positioned at at least three speaker nodes, wherein the virtual surface arrangement is defined at least in part by a virtual surface set comprising a plurality of virtual surfaces, wherein each of the plurality of virtual surfaces is each referenced by a reference means, and wherein the apparatus comprises at least one processor and at least one memory including computer program code, the at least one memory and the computer program code configured to, with the at least one processor, cause the apparatus to:
determine an azimuth angle for each virtual surface of the virtual surface set;
arrange the virtual surfaces of the virtual surface set into an order based on the determined azimuth angles to give an ordered virtual surface set;
determine at least two search sectors, wherein each of the at least two search sectors occupies a range of azimuth angles;
associate a virtual surface of the ordered virtual surface set to each of the at least two search sectors;
obtain a target panning direction comprising at least a target azimuth angle;
determine a search sector from the at least two search sectors based on the target azimuth angle; and
start from the associated virtual surface for the determined search sector, search the ordered virtual surface set to determine a virtual surface that encloses the target panning direction.

2. The apparatus as claimed in claim 1, wherein the reference means is an index.

3. The apparatus as claimed in claim 2, wherein the apparatus caused to start from the associated virtual surface for the determined search sector, search the ordered virtual surface set to determine a virtual surface that encloses the target panning direction is further caused to:
determine an initial search index for the determined search sector, wherein the initial search index is an index of the associated virtual surface for the determined search sector;
determine a set of panning gains for the at least three speaker nodes of the associated virtual surface for the determined search sector; and
determine that the associated virtual surface encloses the target panning direction when each panning gain is non-negative of the set of panning gains for the at least three speaker nodes of the associated virtual surface for the determined sector.

4. The apparatus as claimed in claim 3, wherein when at least one panning gain of the set of panning gains for the speaker nodes of the associated virtual surface for the determined sector is not non-negative, the apparatus is further caused to:
select a further virtual surface from the ordered virtual set with an index which lies to one side of the initial search index;
determine a set of panning gains for the at least three speaker nodes of the further virtual surface; and
determine that the further virtual surface encloses the target planning direction when each panning gain is non-negative of the set of panning gains for the at least three speaker nodes of the further virtual surface; and
when at least one panning gain of the set of panning gains for the at least three speaker nodes of the further virtual surface is not non-negative, the apparatus is further configured to:
select a yet further virtual surface from the ordered virtual set with an index which lies to the other side of the initial search index;
determine a set of panning gains for the at least three speaker nodes of the yet further virtual surface; and
determine that the yet further virtual surface encloses the target planning direction when each panning gain is non-negative of the set of panning gains for the at least three speaker nodes of the yet further virtual surface.

5. The apparatus as claimed in claim 1, wherein each of the plurality of virtual surfaces is defined by at least three vectors each pointing to one of the at least three speaker nodes, wherein the apparatus caused to determine an azimuth angle for each virtual surface of the virtual surface set is caused to:
determine, for each virtual surface, a vector sum of the at least three vectors; and
determine the azimuth angle, for each virtual surface, as an angle of the vector sum projected onto a x-y plane.

6. The apparatus as claimed in claim 1, wherein an azimuth angle for the associated virtual surface is a border angle for the determined search sector, wherein the apparatus caused to start from the associated virtual surface for the determined search sector, search the ordered virtual surface set to determine a virtual surface that encloses the target panning direction is further caused to:
determine whether the target azimuth angle is less than the azimuth angle for the associated virtual surface azimuth angle;
when the target azimuth angle is less than the azimuth angle for the associated virtual surface the apparatus is further caused to determine that the associated virtual surface encloses the target panning direction and determine a set of panning gains for the at least three speaker nodes of the associated virtual surface for the determined search sector; and
when the target azimuth angle is not less than the azimuth angle for the associated virtual surface the apparatus is further caused to determine that when the target azimuth angle is less than a border azimuth angle for a further virtual surface of the ordered virtual surface set that the further virtual surface encloses the target panning direction and determine a set of panning gains for the at least three speaker nodes of the further virtual surface.

7. The apparatus as claimed in claim 1, wherein each of the plurality of virtual surfaces is defined by at least three vectors each pointing to one of the at least three speaker nodes, wherein the apparatus caused to determine an azimuth angle for each virtual surface of the virtual surface set is caused to:
determine, for each virtual surface, a first azimuth angle of a first of the at least three vectors;
determine, for each virtual surface, a second azimuth angle of a second of the at least three vectors; and
select the azimuth angle for each virtual surface as the larger of the first azimuth angle and the second azimuth angle.

8. The apparatus as claimed in claim 1, wherein the apparatus is further caused to:
obtain an elevation angle for a horizontal plane within the three-dimensional space, wherein a number of the plurality of speaker nodes are situated on the horizontal plane; and
create an elevation angle range between a minimum elevation angle and the elevation angle for the horizontal plane.

9. The apparatus as claimed in claim 8, wherein the apparatus is further caused to:
create a further elevation angle range between the elevation angle for the horizontal plane and a maximum elevation angle.

10. The apparatus as claimed in claim 8, wherein the apparatus is further caused to:
obtain an elevation angle for a further horizontal plane within the three-dimensional space, wherein a further number of the plurality of speaker nodes are situated on the further horizontal plane; and
create a further elevation angle range between the elevation angle for the horizontal plane and the elevation angle for the further horizontal plane.

11. The apparatus as claimed in claim 10, wherein the apparatus is further caused to:
create a yet further elevation angle range between the elevation angle for the further horizontal plane and a maximum elevation angle.

12. The apparatus as claimed in claim 8, wherein the apparatus is further caused to:
assign the virtual surface set to one of; the elevation angle range, the further elevation angle range and yet further elevation angle range by mapping an elevation angle associated with the virtual surface set to one of; the elevation angle range, the further elevation angle range and yet further elevation angle range.

13. The apparatus as claimed in claim 12, wherein the target panning direction further comprises a target elevation angle, and wherein the apparatus is further caused to:
determine that the target elevation angle lies within one of: the elevation angle range, the further elevation angle range and yet further elevation angle range to give a determined elevation range.

14. The apparatus as claimed in claim 8, wherein the plurality of virtual surfaces with corners positioned at at least three speaker nodes of the plurality of speaker nodes have sides connecting pairs of corners configured to be non-intersecting with the horizontal plane within the three-dimensional space.

15. The apparatus as claimed in claim 10, wherein the plurality of virtual surfaces with corners positioned at at least three speaker nodes have sides connecting pairs of corners configured to be non-intersecting with the further horizontal plane within the three-dimensional space.

16. The apparatus as claimed in claim 1, wherein the order of virtual surfaces of the virtual surface set is an increasing order of the determined azimuth angles of the virtual surfaces.

17. The apparatus as claimed in claim 1, wherein a virtual surface is a loudspeaker triplet comprising three vectors each pointing to a corner of the loudspeaker triplet.

18. A method for spatial audio signal decoding and rendering associated with a plurality of speaker nodes placed within a three dimensional space having virtual surface arrangement comprising a plurality of virtual surfaces, wherein each of the plurality of virtual surfaces has corners positioned at at least three speaker nodes, wherein the virtual surface arrangement is defined at least in part by a virtual surface set comprising a plurality of virtual surfaces, wherein each of the plurality of virtual surfaces is each referenced by a reference means, and wherein the method comprises:
determining an azimuth angle for each virtual surface of the virtual surface set;
arranging the virtual surfaces of the virtual surface set into an order based on the determined azimuth angles to give an ordered virtual surface set;
determining at least two search sectors, wherein each of the at least two search sectors occupies a range of azimuth angles;
associating a virtual surface of the ordered virtual surface set to each of the at least two search sectors;
obtaining a target panning direction comprising at least a target azimuth angle;
determining a search sector from the at least two search sectors based on the target azimuth angle; and
starting from the associated virtual surface for the determined search sector, search the ordered virtual surface set to determine a virtual surface that encloses the target panning direction.

19. The method as claimed in claim 18, wherein the reference means is an index.

20. The method as claimed in claim 19, wherein starting from the associated virtual surface for the determined search sector, search the ordered virtual surface set to determine a virtual surface that encloses the target panning direction further comprises:
determining an initial search index for the determined search sector, wherein the initial search index is an index of the associated virtual surface for the determined search sector;
determining a set of panning gains for the at least three speaker nodes of the associated virtual surface for the determined search sector; and
determining that the associated virtual surface encloses the target panning direction when each panning gain is non-negative of the set of panning gains for the at least three speaker nodes of the associated virtual surface for the determined sector.

21-34. (canceled)
